(19) United States
(12) Patent Application Publication
(10) Pub. No.: US 2021/0296960 A1
(43) Pub. Date: Sep. 23, 2021

(54) ROTOR OF AN ELECTRIC MOTOR

(71) Applicant: Mahle International GmbH, Stuttgart (DE)

(72) Inventor: Patrick Altherr, Stuttgart (DE)

(21) Appl. No.: 17/204,920

(22) Filed: Mar. 17, 2021

(30) Foreign Application Priority Data
Mar. 18, 2020 (DE) 102020203487.7

(51) Int. Cl. H02K 7/00; H02K 7/04; H02K 1/28

(52) U.S. Cl. CPC H02K 7/003; H02K 2201/09; H02K 1/28; H02K 7/04

(57) ABSTRACT

A rotor of an electric motor may include a basic shaft, a plurality of plate stacks, at least one balancing element structured and arranged to offset imbalances, and a drive element. The at least one balancing element and the drive element may be integrally provided as a one-piece, monolithic component.

### CROSS-REFERENCE TO RELATED APPLICATIONS

This application claims priority to German Patent Application No. DE 10 2020 203 487.7, filed on Mar. 18, 2020, the contents of which is hereby incorporated by reference in its entirety.

### TECHNICAL FIELD

The present invention relates to a rotor of an electric motor having a basic shaft and having plate stacks. The invention additionally relates to an electric motor having such a rotor.

### BACKGROUND

Generic rotors of an electric motor usually possess a basic shaft, on which the plate stacks are mounted. Such plate stacks can form for example metallic cores for receiving a coil. Since such rotors in electric motors rotate at comparatively high speeds, centrifugal forces that cannot be underestimated occur if the rotor has an imbalance. Imbalances can comparatively quickly lead to bearing damage and thus to a failure of the electric motor which is why for offsetting these, balancing elements or balancing discs have been provided to date, which offset the imbalance of the rotor. To date, such balancing elements constitute separate components which need not only be produced separately but have to be additionally assembled which means a cost expenditure that cannot be underestimated.

In addition to this, such motors comprise drive elements which form an axial extension to a rotor shaft and drive a unit that is connected to the electric motor. To date, such drive elements were likewise mounted separately on a rotor shaft of the rotor of the electric motor and consequently had to be not only produced separately, but likewise mounted in a separate assembly step.

### SUMMARY

The present invention therefore deals with the problem of stating an improved or at least an alternative embodiment for a rotor of the generic type, which overcomes in particular the disadvantages known from the prior art.

According to the invention, this problem is solved through the subject matter of the independent claim(s). Advantageous embodiments are subject matter of the dependent clam(s).

The present invention is based on the general idea of integrally combining multiple components that were formed separately and also had to be mounted separately up to now, as a result of which both the separate production and also the separate assembly can fall away and because of this a rotor can be produced more cost-effectively and in a more assembly-friendly manner. In the known manner, the rotor of an electric motor according to the invention comprises a basic shaft, for example a hollow shaft, on which the relevant plate stacks are arranged. Such plate stacks form for example metallic cores for receiving coils. Likewise provided is at least one balancing element for offsetting a rotor imbalance. According to the invention, the balancing element and a drive element are now formed integrally and form a one-piece component. Compared with the balancing discs and drive elements produced separately and to be mounted separately up to now, the component with integrated balancing element and drive element now constitutes a one-piece component which can be produced in one production step and assembled in one assembly step. By way of this, a significant cost reduction regarding the production and the manufacture or the assembly of the rotor according to the invention can be achieved.

The component referred to as “drive element” drives a further unit and can therefore be obviously also referred to as output element.

The balancing element and the drive element can also be formed integrally in/on/with a holding device. In this case, the component comprises a holding device formed integrally with the same. Here, the holding device holds both the basic shaft and also the plate stacks and moreover, compared with the balancing discs and drive elements from the prior art produced separately and to be mounted separately up to now, now constitutes an integral assembly that can be produced in one production step and assembled in one assembly step. By way of this, a further function can be integrated in the one-piece component. Here, the drive element can be formed as a cylindrical axial extension and the balancing element as a radial collar on the holding device or the one-piece component, wherein the radial collar and the axial extension are connected to one another via a hollow cylinder section. With such a particularly preferred embodiment of the rotor according to the invention, a fixing of the holding device on the basic shaft via the hollow cylinder section is possible. The radial collar radially projecting from the hollow cylinder section not only forms the balancing element but at the same time a holding collar for holding or fixing the plate stacks, so that these can be purely theoretically arranged with radial distance to the basic shaft, which in turn offers the major advantage that the basic shaft on its outer circumferential surface need not be machined and because of this can be produced more cost-effectively and forms a ventilation space at the same time.

Practically, the holding device, via its hollow cylinder section, is fixed on the basic shaft by means of a press fit. Such a press fit can be established comparatively easily yet extremely reliably and cost-effectively in terms of production, as a result of which the assembly of the rotor on the one hand is possible with high quality and cost-effectively on the other hand.

In a further advantageous embodiment of the solution according to the invention, a spring element is arranged between the holding device, in particular between the radial collar of the balancing element and the plate stacks. By means of such a spring element it is possible to achieve a preload between the holding device or the radial collar of the same and axial front sides of the plate stacks, as a result of which the plate stacks can be reliably held, even at high rotational speeds and high centrifugal forces occurring in the process. By means of such a spring element it is additionally possible to comparatively easily compensate for production-related manufacturing tolerances, as a result of which higher dimensional tolerances can be tolerated, which likewise makes possible a more cost-effective manufacture.

Practically, the spring element is formed as annular wave disc or as elastic plastic part. An elastic plastic part can be formed for example as plastic ring disc and because of its rubber-like character generate a high adhesive friction between the plate stacks and the spring element, which results in increased holding forces. It is likewise conceivable that the spring element is formed as annular wave disc, wherein such a annular wave disc can be formed for example from metal, in particular from sheet metal, or from plastic. Here, an “annular wave disc” means that individual valley peaks and valley troughs of the annular wave disc are arranged annularly/circularly and because of this can be compressed through an axial preload of the radial collar against the plate stacks in terms of the amplitude. Independently of the described embodiment, both spring elements offer the possibility of offsetting manufacturing-related dimensional tolerances and generate an elastic preload between the holding device, i.e. the radial collar of the same, and the plate stacks, as a result of which an improved fixing of the plate stacks on the rotor can be achieved.

Practically, the drive element or output element has a smaller outer diameter than the basic shaft. This offers the major advantage that no intermediate element for connecting to the transmission, the drive or for example sensors have to be provided.

In a further advantageous embodiment of the solution according to the invention, the plate stacks are axially connected to one another in a positive-locking manner and/or bonded to one another. By way of this it is possible that the plate stacks are already held together, as a result of which even plate stacks, which do not directly come into contact with a spring element or a radial collar of the holding device, can be reliably fixed.

In a further advantageous embodiment of the rotor according to the invention, the plate stacks and the holding device are axially connected to one another in a positive-locking manner. Such an axial positive-locking connection can be constituted for example by recesses which are arranged in the radial collar of the holding device, i.e. in the concrete case in the balancing element of the holding device, into which the plate stacks preferentially engage in a positive-locking manner. When such recesses are closed on an outer edge situated in the radial direction it is conceivable to reliably fix the plate stacks on the rotor merely by way of the positive-locking connection with the holding device. In this case, no spring element would be provided between the respective plate stack and the balancing element.

Additionally or alternatively it is obviously also conceivable that the plate stacks and the holding device or the basic shaft are bonded to one another. Today, such bonded connections can be cost-effectively produced and because of the high holding forces that can be generated by adhesives are capable of reliably holding the plate stacks on the rotor even exclusively by way of a bonded connection.

In a further advantageous embodiment of the solution according to the invention at least one bore for offsetting an imbalance is provided in the balancing element. For offsetting an imbalance of the rotor, either additional weights can be arranged on the balancing element or recesses or weight reductions carried out on the same, wherein by way of such weight reductions, for example recesses or bores, the imbalance of the rotor is at least reduced preferentially even completely eliminated. Compared with additional balancing weights, the bores provided according to the invention constitute a major advantage since the same do not generate any additional weight but even reduce the overall weight of the rotor and are yet capable of offsetting any imbalances that may be present.

In a further advantageous embodiment of the invention, the component with drive element and balancing element is formed as a plug and engages in the basic shaft, or is in particular pressed into the same. In this case, an installation space-optimised arrangement can be achieved.

In an advantageous further development of the solution according to the invention, the basic shaft is formed as a tube. By way of this it is possible to significantly reduce the weight compared with a solid shaft and at the same time maintain a comparatively high stiffness of the basic shaft.

Generally, two such components with holding devices described in the preceding paragraphs can obviously also be provided for each rotor, between which the basic shaft and the plate stacks are clamped. Purely theoretically, merely providing a single holding device is obviously also conceivable. It is also conceivable that on the one hand a plug as one-piece component and on the other hand a holding device are provided.

Furthermore, the present invention is based on the general idea of equipping an electric motor with such a rotor and by way of this to be able to produce a high-quality yet cost-effective electric motor.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1 shows a sectional representation through a rotor according to the invention of an electric motor likewise according to the invention,

FIG. 2 shows a sectional representation through a further embodiment of the rotor according to the invention.

### DETAILED DESCRIPTION

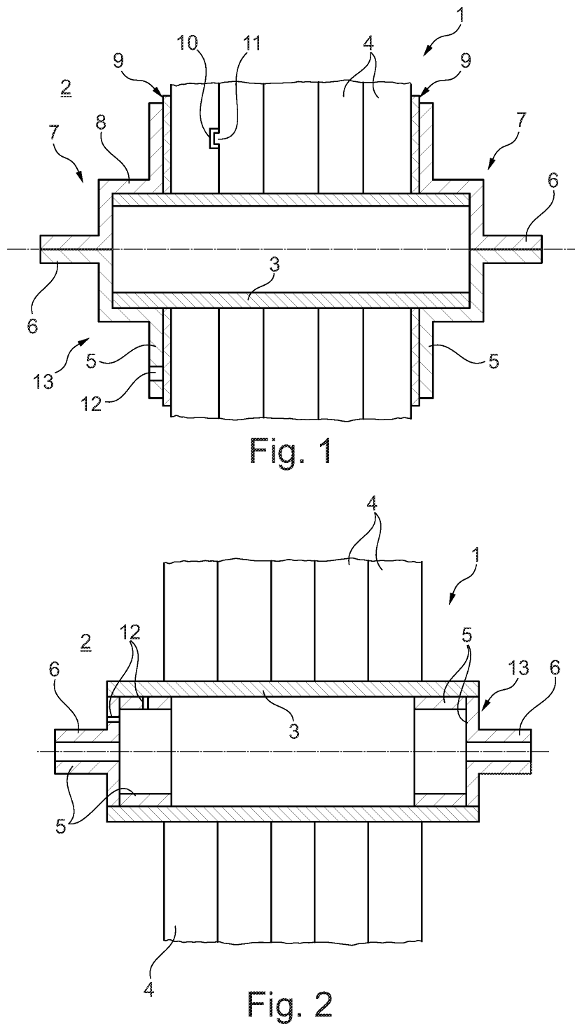

According to FIGS. 1 and 2, a rotor 1 according to the invention of an electric motor 2 which is otherwise not shown, comprises a basic shaft 3, on which the plate stacks 4 are arranged. Likewise provided is at least one balancing element 5, according to FIG. 1 even two balancing elements 5, for offsetting imbalances of the rotor 1. According to the invention, the balancing element 5 and a drive element 6 are now formed integrally and form a one-piece component 13. According to FIG. 1, the component 13 additionally forms a holding device 7 for fixing the plate stacks 4.

According to FIG. 1, two holding devices 7 are drawn in on the rotor 1, wherein it is obviously also conceivable that such a rotor 1 merely comprises a single component 13 with holding device 7, a balancing element 5 and a drive element 6.

With the holding device 7 it is possible for the first time to now combine and integrally form a previously separate balancing disc and a separate drive element in the holding device 7, so that the holding device 7 with the drive element 6 and the balancing element 5 can be produced in a common manufacturing process and assembled in a common assembly process.

The drive element 6 can be formed as cylindrical axial extension while the balancing element 5 can be formed as a radial collar. According to FIG. 1, the radial collar 5 and the axial extension are connected to one another via a hollow cylinder section 8. Here, the holding device 7 can be connected to the basic shaft 3 via its respective hollow cylinder section 8, for example via a press fit, a bonding, a soldering or a thermal joining method.

Viewing FIG. 1 in more detail it is noticeable that between the holding device 7, in particular between the radial collar or the balancing element 5, and the plate stacks 4 a spring element 9 is arranged which makes possible to compensate for axial dimensional inaccuracies. It is likewise conceivable here that when pressing the holding device 7 via its hollow cylinder section 8 onto the basic shaft 3 an axial preloading of the plate stacks 4 occurs that is so strong that the same are reliably held and require no further fixing. Obviously, it is also conceivable here that merely one such spring element 9 is provided, i.e. other than currently shown in FIG. 1.

The spring element 9 can be formed for example as annular wave disc or as elastic plastic part, wherein according to FIG. 1 it is represented as annular wave disc. Such an annular wave disc has circular wave peaks and wave troughs and makes possible a compression in the axial direction and thereby a spring preload of the plate stacks 4 or also a compensation of any axial dimensional inaccuracies that may be present.

Here, the individual plate stacks 4 can be axially connected to one another in a positive-locking manner, so that in one of the plate stacks 4 for example a recess 10 is provided, into which an adjacent plate stack 4 with a corresponding extension 11 engages. Additionally or alternatively, the individual plate stacks 4 can obviously also be bonded to one another.

Analogously it is also conceivable that the plate stacks 4 and the holding device 7 are axially connected to one another in a positive-locking manner for example in the same way as the previously described plate stacks 4 among themselves, wherein it is also obviously conceivable here that the plate stacks 4 and the holding device 7 are bonded to one another.

In order to be able to offset any present imbalances of the rotor 1, at least one bore 12 can be provided in the balancing element 5 according to FIGS. 1 and 2, which can also be generally configured as recess and represents a material reduction and thus a weight reduction or mass reduction. Alternatively it would be obviously also be conceivable to arrange imbalance elements.

In addition to this, the basic shaft 3 can be formed as hollow shaft or as tube and because of this have a comparatively high bending stiffness and low weight at the same time. By way of this it is possible to form the rotor 1 in an altogether weight-reduced manner.

According to FIG. 2, the drive element 6 or the one-piece component 13 is formed as a plug and engages in the hollow shaft 3, or is in particular pressed into the same. There, the section of the component 13 forming the balancing element 5 can engage in the basic shaft 3 and by way of this be arranged in an installation space-optimised manner. Here, the balancing element 5 can obviously also be formed by parts of the drive element 6 or of the radial collar.

With the rotor 1 according to the invention it is now possible to combine components previously produced separately, namely a balancing disc and a drive element, in a one-piece component 13. By way of this, not only can the manufacturing process be kept simpler and more cost-effective but at the same time also an assembly process, since merely a single component 13 has to be assembled with the basic shaft 3 and the plate stacks 4 without a separate assembly of the balancing element 5 or of the drive element 6 having to take place.

By way of the rotor 1 according to the invention, the electric motor 2 according to the invention can also be produced more cost-effectively.

1. A rotor of an electric motor, comprising:
a basic shaft;
a plurality of plate stacks;
at least one balancing element structured and arranged to offset imbalances;
a drive element; and
wherein the at least one balancing element and the drive element are integrally provided as a one-piece, monolithic component.

2. The rotor according to claim 1, wherein:
the monolithic component includes a holding device integrally formed therewith;
the drive element is structured as a cylindrical axial extension and the at least one balancing element is structured as a radial collar disposed on the holding device; and
the radial collar and the axial extension are connected to one another via a hollow cylinder section.

3. The rotor according to claim 2, wherein the holding device, via the hollow cylinder section, is fixed on the basic shaft via a press fit connection.

4. The rotor according to claim 2, further comprising a spring element arranged between the holding device and the plurality of plate stacks.

5. The rotor according to claim 4, wherein the spring element is configured as at least one of an annular wave disc and an elastic plastic part.

6. The rotor according to claim 2, wherein the plurality of plate stacks and the holding device are axially connected to one another in a positive-locking manner.

7. The rotor according to claim 1, wherein the at least one balancing element includes at least one bore configured to offset an imbalance.

8. The rotor according to claim 1, wherein the monolithic component is structured as a plug and engages in the basic shaft.

9. The rotor according to claim 1, wherein the drive element has a smaller outer diameter than the basic shaft.

10. The rotor according to claim 1, wherein the plurality of plate stacks are connected to one another in a positive-locking manner.

11. The rotor according to claim 1, wherein the basic shaft is structured as a tube.

12. An electric motor, comprising a rotor including:
a basic shaft
a plurality of plate stacks;
at least one balancing element structured and arranged to offset imbalances;
a drive element and
wherein the at least one balancing element and the drive element are integrally provided as a one-piece, monolithic component.

13. The electric motor according to claim 12, wherein:
the monolithic component includes a holding device integrally formed therewith;
the drive element is structured as a cylindrical axial extension and the at least one balancing element is structured as a radial collar disposed on the holding device; and
the radial collar and the axial extension are connected to one another via a hollow cylinder section.

14. The electric motor according to claim 13, wherein the holding device, via the hollow cylinder section, is fixed on the basic shaft via a press fit connection.

15. The electric motor according to claim 13, further comprising a spring element arranged between the holding device and the plurality of plate stacks, wherein the spring element is configured as a plastic and elastic annular wave disc.

16. The electric motor according to claim 12, wherein the at least one balancing element includes at least one bore configured to offset an imbalance.

17. The rotor according to claim 1, wherein the plurality of plate stacks are bonded to one another.

18. The rotor according to claim 2, further comprising a spring element arranged between the balancing element and the plurality of plate stacks.

19. The rotor according to claim 2, wherein the plurality of plate stacks and the holding device are bonded to one another.

20. The rotor according to claim 4, wherein the spring element is configured as an annular wave disc.
